(19) United States
(12) Patent Application Publication
(10) Pub. No.: US 2024/0402288 A1
(43) Pub. Date: Dec. 5, 2024

(54) SENSOR FOR DETECTING THE SURROUNDINGS

(71) Applicant: Robert Bosch GmbH, Stuttgart (DE)

(72) Inventors: Michael Schaeuble, Vaihingen An Der Enz (DE); Anisha Saxena, Hirschberg (DE); Daniel Weiler, Ottersweier (DE)

(21) Appl. No.: 18/671,101

(22) Filed: May 22, 2024

(30) Foreign Application Priority Data
May 31, 2023 (DE) 10 2023 205 057.9

(51) Int. Cl. G01S 7/02; G01S 7/40; G01S 13/931

(52) U.S. Cl. CPC G01S 7/027; G01S 7/40; G01S 13/931

(57) ABSTRACT

A sensor for detecting the surroundings, comprising a signal exchange unit, a power supply, a sensor housing, a transmitter, and a receiver, wherein the transmitter and the receiver are arranged in the sensor housing, wherein the transmitter is designed to emit a measuring radiation into the surroundings, wherein the receiver is designed to receive a reflection radiation from the surroundings, wherein the power supply is arranged to supply the transmitter and the receiver with power, wherein the signal exchange unit is connected to the receiver and the transmitter for signal exchange, wherein the signal exchange unit is arranged to exchange signals with a counter-signal exchange unit, and the sensor housing can be mechanically connected to a receiving unit in a tool-free, non-destructive and detachable manner.

### BACKGROUND

The present invention relates to a sensor for detecting the surroundings.

Vehicles use sensors to perceive their surroundings. In most cases, these sensors are either fitted behind the windshield of the vehicle or distributed along the outer skin of the vehicle. The information from the sensors is then evaluated by driver assistance systems. Driver assistance systems make their decisions based on this evaluation. In most cases, the sensors are components that the OEM buys from suppliers and installs in their fixed position, for example in the outer skin of the vehicle, using tools during vehicle production. The individual sensor cannot be replaced by the vehicle owner. To replace the sensors, parts of the vehicle's outer skin must be removed and/or the sensors removed using special tools. The customer has to drive to the workshop to replace the sensors.

In the truck sector, sensors are not only fitted to the tractor units, but also to the trailers. This allows an improved perception of the truck's surroundings. In contrast to tractor units, trailers have a long service life during which they are not moved. The sensors are not required during these downtimes.

### SUMMARY

The sensor according to the invention for detecting the surroundings allows the sensor to be attached to and removed from vehicles in such a way that the data of the sensor can be used by systems of the vehicle, by a vehicle owner himself. For example, sensors can be removed from trailers while they are stationary and attached to trailers that are in use.

The sensor comprises a signal exchange unit, a power supply unit (or power supply), a sensor housing, a transmitter unit (or transmitter) and a receiver unit (or receiver). The transmitter unit and the receiver unit are arranged in the sensor housing. The transmitter unit is designed to emit measuring radiation into the surroundings. The receiver unit is designed to receive reflected radiation from the surroundings. The power supply unit is set up to supply the transmitter unit and the receiver unit with power. The signal exchange unit is connected to the receiver unit and the transmitter unit for signal exchange. The signal exchange unit is set up to exchange signals with a counter-signal exchange unit. The signal exchange can be one-way, so that only signals are transported from one unit to the other, or two-way, so that signals are transported bidirectionally between the units. The sensor housing can be mechanically connected to a receiving unit in a non-destructive, tool-free manner.

The sensor is therefore able to scan the surroundings using the transmitter unit and the receiver unit. The surroundings data determined by this scanning process can then be exchanged with a counter-signal exchange unit using the signal exchange unit. The counter-signal exchange unit can in turn be connected to systems in a vehicle and/or trailer. In this way, surroundings data is transferred from the sensor to driver assistance systems in the vehicle. When the sensor is used in a vehicle and/or a trailer, the sensor is connected to a receiving unit. The receiving unit can be arranged on the vehicle and/or the trailer.

As the sensor can be mechanically connected to the receiving unit without the need for tools and can be detached in a non-destructive manner, the sensor can be replaced by the vehicle owner. The vehicle owner does not have to drive to a workshop to change the sensor. Sensors can also be removed from trailers that are temporarily not in use. The remote sensors can be attached to a trailer that is actually used. The same can be done analogously for a fleet of vehicles if not every vehicle in the fleet is in continuous use. This procedure allows the number of sensors required to be reduced to the actual number of sensors required based on the vehicles and/or trailers actually used. This reduces the acquisition and maintenance costs for a fleet of vehicles and/or trailers. Consequently, the sensor ensures a comparable detection of the surroundings compared to conventional sensors and is also more cost-effective for a vehicle owner and/or fleet operator.

Preferably, the power supply unit comprises a current source and/or a current contacting element. The power source is located in the sensor housing. A current contacting element is arranged on and/or in the sensor housing in such a way that the current contacting element can be electrically contacted for a counter-current contacting element of the receiving unit. In one configuration of the power supply unit as a power source, the power source is located within the sensor and is designed, for example, as a battery, in particular a rechargeable battery. This ensures that the sensor is powered independently of an external power supply. Furthermore, there is no need for an external power supply to the receiving unit. This makes it easier to retrofit the sensor to a vehicle and/or trailer. If the power supply unit is configured as a current contact element, the weight, manufacturing costs and size of the sensor are reduced compared to other power supply configurations.

The signal exchange unit is particularly preferably set up to exchange signals with the counter-signal exchange unit via a wireless signal connection. Alternatively or additionally, the signal exchange unit has a signal contacting element. The signal contacting element is arranged on and/or in the housing in such a way that the signal contacting element can be electrically contacted for a counter-signal exchange unit in the receiving unit. If the signal exchange unit is configured as a wireless signal connection, direct contact between elements for signal exchange is avoided. This means that the signal exchange unit does not have to be positioned so precisely in the receiving unit that electrical contact occurs. In addition, wear of such physical contacting is avoided. Furthermore, a wireless configuration of the signal exchange unit also enables vehicles and/or trailers to be retrofitted with the sensor. In a configuration in which the signal exchange unit has a signal contacting element, the manufacturing costs and the manufacturing costs are minimized compared to alternative configurations.

Advantageously, the sensor housing can be connected to the receiving unit in a force-fit and/or form-fit manner. This makes it particularly easy for a user, such as the vehicle owner, to connect and disconnect the sensor to the receiving unit.

The sensor has a cleaning unit, which is particularly advantageous. The cleaning unit is designed to clean one surface of the sensor. The cleaning unit is located in the sensor housing. This means that no cleaning unit needs to be provided on the vehicle and/or trailer. This makes it easier to retrofit the vehicle and/or trailer to receive the sensor. Furthermore, a cleaning unit ensures that the sensor is clean and thus guarantees high reliability of the sensor, as the measuring beams are not affected by soiling.

Preferably, the sensor has a cleaning supply unit. The cleaning supply unit is designed to supply the cleaning unit with a cleaning fluid. The cleaning supply unit has a cleaning fluid container. Alternatively or additionally, the cleaning supply unit has a cleaning fluid connection. The cleaning fluid connection is arranged on and/or in the housing in such a way that the cleaning fluid connection can be fluidically contacted for a counter-cleaning fluid connection of the receiving unit. A cleaning fluid container ensures that the cleaning supply unit is supplied with cleaning fluid independently of an external connection. This makes it easy to retrofit a vehicle and/or trailer with a sensor without having to subsequently insert a fluid line into the vehicle up to the receiving unit. Configuring the cleaning supply unit with a cleaning fluid connection reduces the size and manufacturing costs of the sensor. Separate refilling of the fluid supply of individual sensors is also avoided.

Furthermore, the invention comprises a receiving unit for receiving a sensor according to one of the previous embodiments. The receiving unit comprises a receiving housing and a counter-current contact element. The receiving housing can be mechanically connected to a sensor housing of the sensor in a non-destructive, tool-free manner. The counter-current contact element is arranged in the receiving housing and can be contacted by a current contact element in the sensor. The fact that the sensor can be mechanically connected to a sensor housing of the receiving unit in a tool-free, non-destructive manner makes it possible for a user to connect the sensor to the receiving unit independently. This has the advantages listed above for the sensor. Furthermore, the simple configuration of the receiving unit allows the receiving unit to be retrofitted to vehicles at low cost.

Preferably, the receiving unit has a counter-signal exchange unit. The counter-signal exchange unit is set up to exchange signals with a signal exchange unit of the sensor. This allows the inclusion of a sensor with a signal exchange unit and brings the associated advantages.

It is particularly preferable that the receiving housing can be connected to the sensor housing in a non-destructive, force-fit and/or form-fit manner. This makes it particularly easy for a user, such as the vehicle owner, to connect and disconnect the sensor to the receiving unit.

Advantageously, the receiving unit has a counter-cleaning fluid connection. The counter-cleaning fluid connection is located in the receiving housing and can be fluidically connected to the cleaning fluid connection of the sensor. This allows a sensor with a cleaning fluid connection to be fitted and brings the associated advantages.

Preferably, the receiving unit can be connected to the sensor housing by means of a snap-in connection. This allows a secure connection between the receiving housing and the sensor. Furthermore, a snap-in connection allows precise alignment of the sensor relative to the receiving housing.

It is particularly preferable for the receiving housing to have an insertion slope. This makes it easier to insert the sensor into the receiving unit. The sensor housing preferably has an insertion slope. This makes it easier to insert the sensor into the receiving unit.

Advantageously, the receiving housing is rotationally symmetrical. This makes it easy to manufacture the receiving housing. Advantageously, the sensor is rotationally symmetrical. This makes it easy to manufacture the sensor housing. Advantageously, the receiving housing and the sensor housing are rotationally symmetrical. This allows both simple production of the receiving housing and the sensor housing, as well as a good fit between the receiving housing and the sensor housing.

A particularly advantageous design of the sensor is that the sensor housing is flush with an insertion opening of the receiving unit in a state connected to the receiving unit. This reduces the risk of accidental damage to the sensor, as it is surrounded by the receiving unit and does not protrude.

Preferably, the sensor housing is designed in such a way that the sensor housing can be connected in a force-fit manner to the receiving unit by means of a fit. The fit is selected so that the force-fit connection between the sensor housing and the receiving unit is not overcome by mechanical loads on the sensor during regular use of a vehicle and/or trailer. This means that no additional components are required for the force-fit connection. This reduces the complexity of the sensor component and lowers manufacturing costs.

Preferably, the receiving housing has at least one spring-elastic bearing for force-fit connection with the sensor. This ensures a force-fit connection between the receiving unit and the sensor, even with different sensors of different sizes.

Particularly preferably, the receiving housing has an aperture at the insertion opening for inserting the sensor into the receiving housing. The cover has a first state in which it covers the insertion opening. The aperture has a second state in which it exposes the insertion opening for inserting the sensor into the receiving housing. The cover is used to reduce soiling of the interior of the receiving housing.

The invention further comprises a support structure. The support structure has several holding areas, each of which is set up to hold a receiving unit. The carrier structure can be attached to a vehicle and/or trailer. This allows a large number of receiving units to be retrofitted to a vehicle and/or trailer in one retrofitting process.

### BRIEF DESCRIPTION OF THE DRAWINGS

In the following, embodiment examples of the invention are described in detail with reference to the accompanying drawing. The drawings show:

FIG. 1 a schematic representation of a vehicle with a sensor and a receiving unit according to an embodiment example of the invention,

FIG. 2 a schematic representation of the receiving unit according to the embodiment example of the invention, and

FIG. 3 a schematic representation of the sensor according to the embodiment example of the invention.

### DETAILED DESCRIPTION

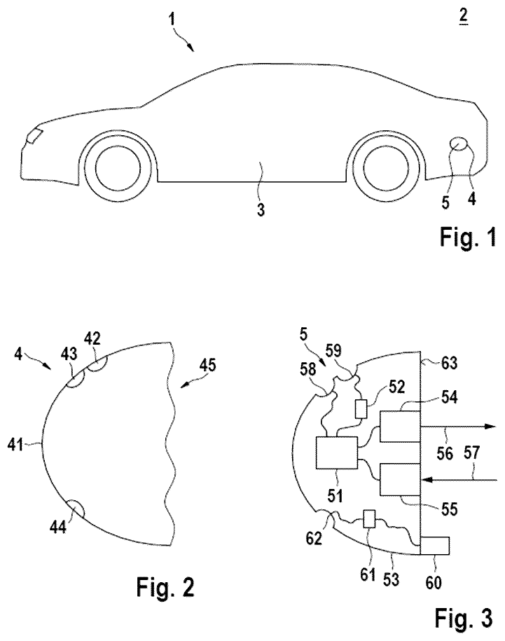

FIG. 1 shows a schematic representation of a vehicle 1 with a sensor 5 and a receiving unit 4 according to an embodiment example of the invention.

The receiving unit 4 is embedded in the outer skin 3 and is flush with it. The sensor 5 is connected to the receiving unit 4 and arranged in the receiving unit 4.

FIG. 2 shows a schematic representation of the receiving unit 4 according to the embodiment example of the invention.

The receiving unit 4 comprises a receiving housing 41 and a counter-current contact element 42. The receiving housing 41 can be mechanically connected to a sensor housing 53 of the sensor 5 in a non-destructive, tool-free, and detachable manner. The counter-current contacting element 42 is arranged in the receiving housing 41 and can be contacted by a current contacting element 59 in the sensor 5. The fact that the receiving unit 4 can be mechanically connected to the sensor housing 53 of the sensor 5 in a tool-free, non-destructive manner makes it possible for a user to connect the sensor 5 to the receiving unit 4 independently. This has the advantages listed above for sensor 5. Furthermore, the simple configuration of the receiving unit 4 allows the receiving unit 4 to be retrofitted to vehicles 1 at low cost.

The receiving unit 4 has a counter-signal exchange unit 43. The counter-signal exchange unit 43 is set up to exchange signals with a signal exchange unit 51 of the sensor 5. This allows a sensor 5 to be accommodated with the signal exchange unit 51 and brings the associated advantages.

The receiving housing 41 can be connected to the sensor housing 53 in a force-fit manner and in a non-destructive and detachable manner. This makes it particularly easy for a user, such as the vehicle owner, to connect and disconnect the sensor 5 from the receiving unit 4.

The receiving unit 4 has a counter-cleaning fluid connection 44. The counter-cleaning fluid connection 44 is arranged in the receiving housing 41 and can be fluidically connected to a cleaning fluid connection 62 of the sensor 5. This allows a sensor 5 to be accommodated with the cleaning fluid connection 62 and brings the associated advantages.

FIG. 3 shows a schematic representation of the sensor 5 according to the embodiment example of the invention.

The sensor 5 comprises the signal exchange unit 51, a power supply unit 52, the sensor housing 53, a transmitter unit 54, and a receiver unit 55.

The transmitter unit 54 and the receiver unit 55 are arranged in the sensor housing 53. The transmitter unit 54 is designed to emit a measuring radiation 56 into the surroundings 2. The receiver unit 55 is designed to receive reflected radiation 57 from the surroundings 2. The power supply unit 52 is set up to supply the transmitter unit 54 and the receiver unit 55 with power. The signal exchange unit 51 is connected to the receiver unit 55 and the transmitter unit 54 for signal exchange. The signal exchange unit 51 is set up to exchange signals with the counter-signal exchange unit 43. The sensor housing 53 can be mechanically connected to the receiving unit 4 in a non-destructive, tool-free manner.

The sensor 5 is thus able to scan the surroundings 2 by means of the transmitter unit 54 and the receiver unit 55. The surroundings data determined by this scanning process is then exchanged with the counter-signal exchange unit 43 by means of the signal exchange unit 51. The counter-signal exchange unit 43 is in turn connected to systems in the vehicle 1. In this way, the surroundings data is transferred from sensor 5 to driver assistance systems in vehicle 1.

As the sensor 5 can be mechanically connected to the receiving unit 4 in a non-destructive and tool-free manner, the sensor 5 can be replaced by the vehicle owner. The vehicle owner does not have to drive to the workshop to change the sensor 5. Furthermore, sensors 5 can be removed from vehicles 1, for example in a vehicle fleet, which are temporarily not in use. The removed sensors 5 can now be attached to a vehicle 1, which is used for this purpose. This procedure allows the number of sensors 5 required to be reduced to the actual number of sensors 5 required based on the vehicles 1 actually used. This can reduce the acquisition and maintenance costs for a fleet of vehicles 1. Consequently, the sensor 5 ensures a comparable detection of the surroundings 2, compared to conventional sensors 5, and is also more cost-effective for a vehicle owner and/or fleet operator.

The power supply unit 52 has a current contact element 59. The current contacting element 59 is arranged on the sensor housing 53 in such a way that the current contacting element 59 can be electrically contacted for the counter-current contacting element 42 of the receiving unit 4. This configuration of the power supply unit 52 as a current contact element 59 reduces the weight, manufacturing costs and size of the sensor 5 compared to other power supply configurations.

The signal exchange unit 51 has a signal contacting element 58. The signal contacting element 58 is arranged on the housing in such a way that the signal contacting element 58 can be electrically contacted for the counter-signal exchange unit 43 in the receiving unit 4. This configuration allows the manufacturing complexity and manufacturing costs to be minimized compared to alternative configurations

The sensor housing 53 can be force-fit connected to the receiving unit 4. This makes it particularly easy for a user, such as the vehicle owner, to connect and disconnect the sensor 5 from the receiving unit 4.

The sensor 5 has a cleaning unit 60. The cleaning unit 60 is designed to clean a surface 63 of the sensor 5. The cleaning unit 60 is arranged in the sensor housing 53. This eliminates the need for a cleaning unit 60 on vehicle 1. This makes it easier to retrofit the vehicle 1 to accommodate the sensor 5. Furthermore, a cleaning unit 60 ensures cleanliness of the sensor 5 and thus guarantees high reliability of the sensor 5, as the measuring beams are not impaired by soiling.

The sensor 5 has a cleaning supply unit 61. The cleaning supply unit 61 is designed to supply the cleaning unit 60 with a cleaning fluid. The cleaning supply unit 61 has the cleaning fluid connection 62. The cleaning fluid connection 62 is arranged on the housing in such a way that the cleaning fluid connection 62 can be fluidically contacted for a counter-cleaning fluid connection 62 of the receiving unit 4. This configuration reduces the size and manufacturing costs of the sensor 5.

1. A sensor (5) for detecting the surroundings (2), the sensor comprising:
a signal exchange unit (51),
a power supply (52),
a sensor housing (53),
a transmitter (54), and
a receiver (55),
wherein the transmitter (54) and the receiver (55) are arranged in the sensor housing (53),
wherein the transmitter (54) is designed to emit a measuring radiation (56) into the surroundings (2),
wherein the receiver (55) is designed to receive reflected radiation (57) from the surroundings (2),
wherein the power supply (52) is arranged to supply the transmitter (54) and the receiver (55) with power,
wherein the signal exchange unit (51) is connected to the receiver (55) and the transmitter (54) for signal exchange,
wherein the signal exchange unit (51) is set up to exchange signals with a counter-signal exchange unit (51), and
the sensor housing (53) can be mechanically connected to a receiving unit (4) in a non-destructive, tool-free, and detachable manner.

2. The sensor (5) according to claim 1, wherein the power supply (52)
comprises a current source and the current source is arranged in the sensor housing (53) and/or
has a current contacting element (59) and the current contacting element (59) is arranged on and/or in the sensor housing (53) in such a way that the current contacting element (59) can be electrically contacted for a mating current contacting element (42) of the receiving unit (4).

3. The sensor (5) according to claim 1, wherein the signal exchange unit (51)
is set up to exchange signals with the counter-signal exchange unit (43) via a wireless signal connection, and/or
has a signal contacting element (58) and the signal contacting element (58) is arranged on and/or in the sensor housing (53) in such a way that the signal contacting element (58) can be electrically contacted for a counter-signal exchange unit (43) in the receiving unit (4).

4. The sensor (5) according to claim 1, wherein the sensor housing (53) can be connected to the receiving unit (4) in a force-fit and/or form-fit manner.

5. The sensor (5) according to claim 1, wherein a cleaning unit (60), wherein
the cleaning unit (60) is set up to clean a surface (63) of the sensor (5), and
the cleaning unit (60) is arranged in the sensor housing (53).

6. The sensor (5) according to claim 5, wherein a cleaning supply unit (61), wherein the cleaning supply unit (61) is designed to supply the cleaning unit (60) with a cleaning fluid, wherein
the cleaning supply unit (61) has a cleaning fluid container, and/or
has a cleaning fluid connection (62), and the cleaning fluid connection (62) is arranged on and/or in the sensor housing (53) in such a way that the cleaning fluid connection (62) can be fluidically contacted for a counter-cleaning fluid connection (62) of the receiving unit (4).

7. A receiver (4) for receiving a sensor (5) according to claim 1, comprising
a receiving housing (41), and
a counter-current contacting element (42)
wherein the receiving housing (41) can be mechanically connected to a sensor housing (53) of the sensor (5) in a tool-free, non-destructive and detachable manner, and
the counter-current contacting element (42) is arranged in the receiving housing (41) and can be contacted for a current contacting element (59) in the sensor (5).

8. The receiver (4) according to claim 7, wherein a counter-signal exchange unit (43), wherein the counter-signal exchange unit (43) is set up to exchange signals with a signal exchange unit (51) of the sensor (5).

9. The receiver (4) according to claim 8, wherein the receiving housing (41) can be connected to the sensor housing (53) in a force-fit and/or form-fit, non-destructively detachable manner.

10. The receiver (4) according to claim 8, wherein a counter-cleaning fluid connection (44), wherein the counter-cleaning fluid connection (44) is arranged in the receiving housing (41) and can be fluidically connected to the cleaning fluid connection (62) of the sensor (5).
